(19) United States
(12) Patent Application Publication
(10) Pub. No.: US 2005/0044499 A1
(43) Pub. Date: Feb. 24, 2005

(54) Method for capturing, encoding, packaging, and distributing multimedia presentations

(75) Inventors: Geoffrey Benjamin Allen, Sterling, VA (US); Steven Lee Geyer, Herndon, VA (US); Eric Richard Banker, Ashburn, VA (US); Rodney Dale McElrath, Fairfax, VA (US); Timothy Scott Ramsey, Chantilly, VA (US); Thomas Alan Brooks, Ashburn, VA (US); Gregory Thomas Letourneau, Ashburn, VA (US)

Correspondence Address: Ronald Abramson;Hughes Hubbard & Reed LLP, One Battery Park Plaza, New York, NY, 10004-1482, US

(73) Assignee: Anystream, Inc., Sterling, VA (US)

(21) Appl. No.: 10/783,809

(22) Filed: Feb. 20, 2004

Related U.S. Application Data
(60) Provisional application No. 60/449,472, filed on Feb. 23, 2003.

(51) Int. Cl. G09G 5/00

(52) U.S. Cl. 715/704; 715/716; 715/719; 715/723; 715/727

(57) ABSTRACT

A method for creating a multimedia presentation, which presentation comprises an audio or video recording of a session wherein a presenter presents an audiovisual presentation, said method comprising said presenter presenting said audiovisual presentation, making an audio or video recording of said presentation, wherein timing data comprising data for start, end and transition events within said audiovisual presentation are automatically, and without manual processing, incorporated into said audio or video recording, so as to allow said events to be used on playback to coordinate the audio or video portion of said multimedia presentation with the audiovisual portion thereof.

### CROSS REFERENCE TO RELATED APPLICATION

This application claims the benefit and the priority of the previously filed U.S. provisional application 60/449,472, filed Feb. 23, 2003 (including the computer program appendix identified therein), and the computer program listing appendix to the present submission, submitted herewith on a compact disc, containing the following material:

File Name Date of Creation Size (Bytes) ApresoSetup.msi Oct. 31, 2003 6,707,000

### BACKGROUND OF THE INVENTION

1. Field of the Invention

This patent is in the field of computer software, and more particularly defines a method to simplify the creation of redistributable multimedia presentations.

2. Description of Related Art

The current methods to capture presentations and then to create redistributable multimedia presentations are clumsy, require specialized skills, have many steps, and are time consuming and error-prone. As a result, these multimedia presentations are typically expensive and often not available until many days or weeks after the live presentation was completed. FIG. 1 shows this process in action. On the left side of this diagram, a meeting is underway where the presenter 101 is showing and discussing presentation slides 102 with the other participants in the meeting. After the meeting is over, an electronic record of this meeting is created that can be played back and reviewed at a later time. Ideally, this record would be a multimedia presentation having the slide content synchronized to the conversation playback along with some method for selecting a particular part of the conversation for replay.

The right hand side of FIG. 1 shows an application program, such as a web browser or a Macromedia Flash® player, displaying one of these multimedia presentations 103. The display of this player is broken into several logical sections which can be laid out in many different configurations. In the upper left of this example is the audio and/or video playback 104 area. This is where video is shown and it may be omitted in audio-only presentations. The control 105 section controls the presentation playback using common tape or VCR style controls of play, pause, fast forward and rewind. Under that, metadata about the presentation is shown 106. This is information like when and where the presentation was captured, its title, and a table of contents generated using slide content. Commonly, if the user clicks on an entry in the table of contents, the playback jumps to that section in the conversation. The last section on the screen is where the slide content is displayed 107.

While the example in FIG. 1 shows a formal meeting, this same technology can support informal discussions of two or more parties sitting around small table. It also supports self-publishing where the presenter creates the presentation in their office and then sends the finished multimedia presentation to those they wish to view it.

FIG. 2 shows the steps and processes required by current methods. The steps requiring manual human intervention are indicated with an “M”s in their upper right corner. The process begins when the presenter is ready to deliver the presentation and the device recording the presentation is started 201. This recording device can be a tape record, camcorder or a digital device connected to a microphone or camera. Once recording has begun, the presenter starts the presentation program like Microsoft PowerPoint 202, and then shows a series of slides 203 and discusses them. Once the presentation is completed, the recording is stopped 204. Commonly, the presenter delegates the management the recording device to another so they can focus on the presentation they are delivering.

After the presenter has finished giving and captured the presentation, other program(s) specialized in the creation of multimedia presentations are used to perform tasks 205-210. These tasks may occur several days or weeks after the presentation was originally presented because of expense or other resource constraints. This can diminish the value of the resulting multimedia presentation as the content of communications are often time-sensitive.

Task 205-209 can be performed in any order as long as task 205 is done before step 206. Since the recording of the presenter was started and stopped manually, it often has unnecessary material at the beginning and end of the recording. Task 205 uses a media editing program such as Microsoft Producer to trim the audio or audio/video clip and eliminate this undesired material. Once the recording is ready, it is converted into a form for digital delivery and playback 206. On the Internet, this may be a streaming audio/video format (such as Windows Media Format) or other multimedia formats such as Macromedia Flash. Another task ingests the slide contents, often in the native format used by the presentation program, and transforms that into a form appropriate for multimedia delivery 207. This task may optionally take the same slide content and extracts additional metadata. This metadata can be in many forms, such as a table of contents, a textual representation of the slide content or a search engine that returns specific slides based on their content. The user of the production software must also supply slide timing to help the production software synchronize the slide transitions with the audio or audio/video. This information can be generated from a separate program running while the presenter gives the presentation 208 or it may be a specialized editor inside the production program that uses a timeline display of the slides and a timeline of the audio or audio/video and allows the user to mark the slide transition events specifically 209.

From all of this information the final multimedia package is created 210. This step glues all of the data together into a single package for distribution and viewing. One important step is to synchronize the audio or audio/video delivery with the slide transitions. This can be done in several different ways depending on the ultimate delivery format. On the Internet, the two most common methods are to insert timing markers in a media stream and have the media viewer trigger the slide changes, or to use an external timing format (such as JavaScript or SMIL) to control events.

Sometimes the program used to produce multimedia presentations is separated into multiple programs that specialize in different aspects of the process. A common approach requires one program to transform the audio or audio/video into a delivery format, another program to capture the slide timing events and a final program to integrate all of the information into the finished multimedia presentation. The users operating each of the programs are often required to possess different skills (e.g. video encoding skills verses multimedia development skills).

It is important to note that the production of multimedia content requires many skills not common to the large audience of people who give presentations. While they may desire a multimedia version of their presentation to be generated, unless they or others assisting them know how, this process is typically out of their reach.

### BRIEF SUMMARY OF THE INVENTION

This patent defines a method to simplify the creation of redistributable multimedia presentations. As noted above, the current methods used to capture presentations and then to create multimedia presentations are clumsy, require specialized skills, have many steps, and are time consuming and error-prone. The method described in this patent automates these steps and takes advantage of information already supplied by the user, such as the electronic content of their slides and when they transition the slides, to allow average users of presentation software to complete the entire process with little to no additional effort.

The manner in which the invention operates, and how it overcomes the shortcomings of the prior art, is more fully explained in the detailed description that follows, and illustrated in the accompanying drawings and accompanying compact disc.

### BRIEF DESCRIPTION OF THE DRAWINGS

FIG. 1 is an overview of the prior art in presentation capture to the creation of a multimedia presentation.

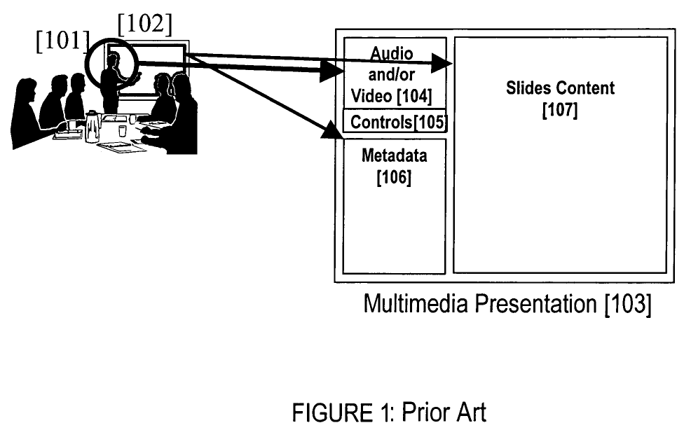

FIG. 2 shows an existing method for creating multimedia presentations.

FIG. 3 is a flow chart of this invention.

FIG. 4 shows a current implementation of this invention.

FIG. 5 shows an alternative embodiment of the invention.

### DETAILED DESCRIPTION

The Appendix hereto contains the object code for an installable and operable embodiment of the invention.

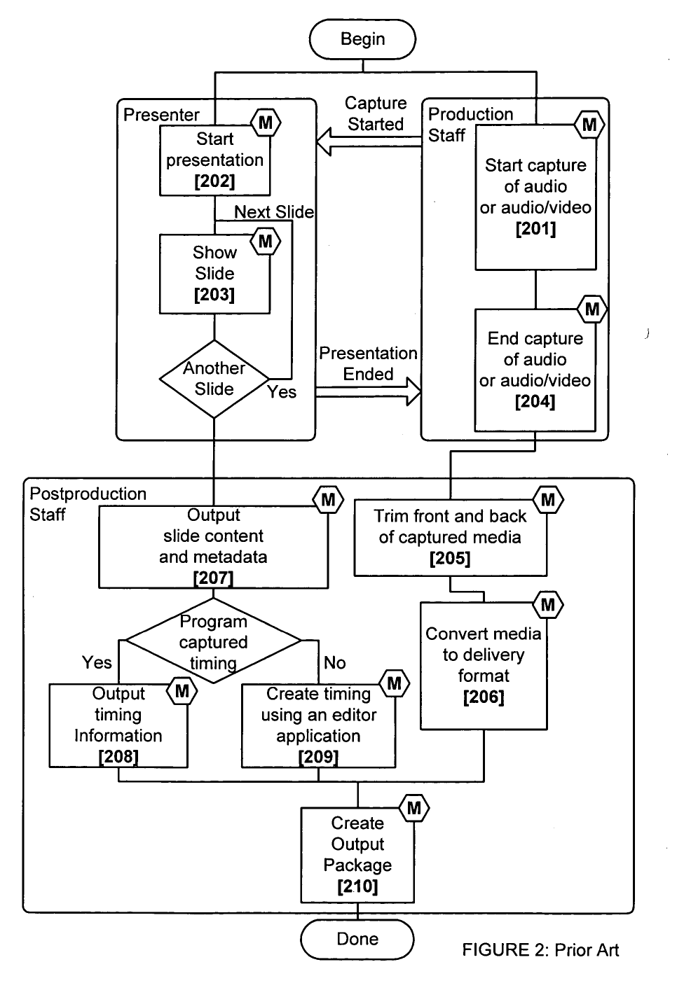

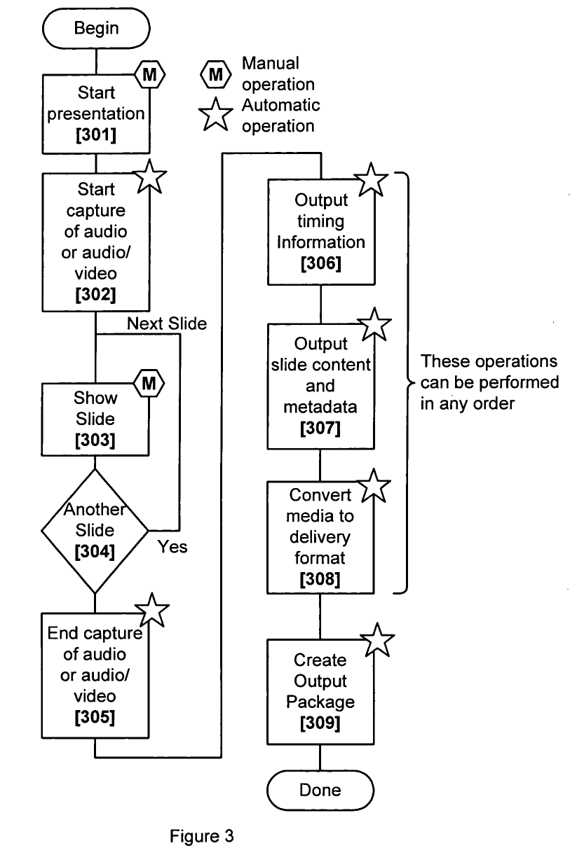

FIG. 3 shows the steps and processes required for the invention. Just like FIG. 2, processing steps requiring manual human intervention are indicated with an “M”s in their upper right corner. Steps that happen automatically as part of the invention's workflow are depicted with a star in their upper right corner.

The process begins with the presenter starts a presentation 301 using a software program like Microsoft PowerPoint. A separate software component, running along side the presentation program, monitors presentation program activity and performs all automatic steps shown in the figure. Immediately after the presenter starts his presentation 301, the monitoring program starts an audio or audio/video capture of the presentation 302. This process of media capture and processing may reside on the machine the presenter is doing their presentation from or it may be on a separate machine connected over a data network. When starting the capture and processing step 302, it may optionally start converting the media into a delivery format 308 to speed up the processing at multimedia presentation creation time after the presenter finishes giving his presentation. It may also start a screen capture of the screen content (PowerPoint slides and/or other user applications) being shown to the audience. This content can then be processed to create images of each slide or a movie showing all animations and changes to the screen. This option will be discussed in more detail below.

The presenter then delivers their presentation normally using the presentation program. The monitoring program also tracks the progress of the presentation program to determine when the presenter shows the first slide 303, transitions the slides 304 or pauses the presentation (not shown in figure). In one embodiment, this information is stored internally in an add-in for later processing. When the presenter finishes the presentation, the monitoring program ends the audio or audio/video capture 305 and starts a series of tasks 306-308. These tasks can be done in any order. It outputs the slide timing data 306. It also transforms the slide content into a form appropriate for multimedia delivery 307. This task optionally takes the same slide content and extracts additional metadata for the user. This metadata can be in many forms, such as a table of contents, a textual representation of the slide content or a search engine that returns specific slides based on their content. Finally, its converts the recorded presentation into a format appropriate for delivery 308. As mentioned earlier, task 308 may be executed simultaneously with the audio or audio/video capture.

Using all of this information the final multimedia package is created 309. This step glues all of the data together into a single package. One important step is to synchronize the audio or audio/video delivery with the slide transitions. This can be done in several different ways depending on the ultimate delivery format. On the Internet, the two most common methods are to insert timing markers in a media stream and have the media viewer trigger the slide changes, or to use an external timing format (such as JavaScript or SMIL) to control events. In either case, this final processing happens automatically and without user intervention.

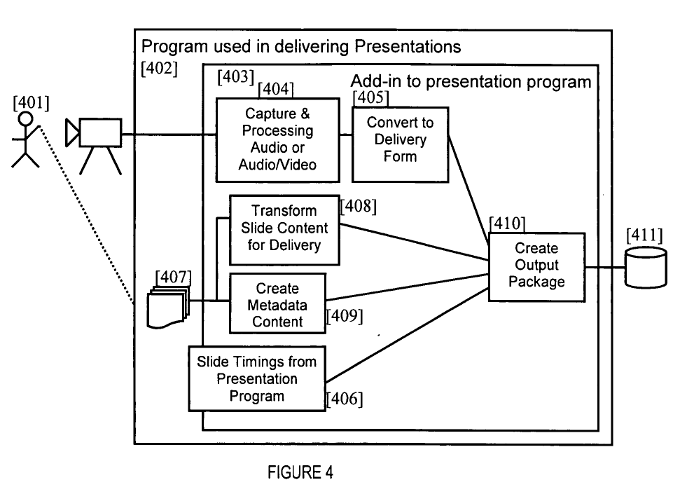

The embodiment for this invention varies in implementation based on the operating environment and the software program being modified. FIG. 4 shows a current embodiment of the invention, in which the operating environment is Microsoft Windows and the Microsoft PowerPoint is the programming being modified. It begins with the presenter 401 using Microsoft PowerPoint 402 to deliver the presentation. This presentation program 402 has a standard Microsoft PowerPoint add-in 403 inserted into its operation. This add-in attaches itself into PowerPoint so it is simultaneously started when the user starts a presentation 301.

The add-in 403 immediately begins the capture and processing of audio or audio/video 404, 302. This process of media capture and processing may reside on the machine the presenter is doing their presentation from or it may be on a separate machine connected over a data network. When starting the capture and processing step 404, it may optionally start converting the media into a delivery format 405, 308. There are many methods that can be employed on a Microsoft Windows environment to perform this capture. The two most likely are to use a DirectX capture graph or to use the Windows Media Encoder object. Both these methods can be used to capture 404 and immediately encode into the deliver format 405, 308. Doing both these steps in parallel shortens the post-processing time to create the final presentation. Our experience shows that using the Windows Media Encoder object running within a PowerPoint thread delivers the best quality video in the final presentation.

Another important option that may start with step 404 is a screen capture of the slides being presented 408, 307. This is accomplished by periodically capturing all of the data in the screen buffer and processing this data to create an output file. Two broad options are available for processing; the first creates images of the slide content and the other creates a movie of the changing slide content. To create images, the program can periodically capture the screen and output an image. The other option is to do a frame by frame analysis of the screen and determine when the frame has changed enough to warrant an image to be captured and output in a standard image format (like GIF, JPEG, or PNG). This later approach is more computationally difficult but it generates fewer images and therefore takes up less disk space. To create a movie of the slide content, the screen is captured at constant rate between 1 and 30 frames a second with 5 to 10 frames a second is being optimal. It is then processed for output. This processing can either be the compression into a conventional streaming media format like the Windows Media Screen codec or it can be processed to create an alternative playback format. A very useful alternative format is Macromedia Flash where the processing creates a “flip-book” of images. The flip-book is created by doing a frame by frame comparison of the screen capture and outputting images on the Flash timeline when there is a change in the image. Many third party libraries exist that can be used to create the Flash output. By using Flash, most users on Windows, Macintosh, Unix and Linux computers can play back the results. The advantages of creating a movie of the slide presentation is that it accurately captures the animations in the presentation, it captures any “electronic ink” or annotations made on the screen (using electronic pens found in PowerPoint, Tablet-based PCs or other annotation software), and it can capture the output of other software programs (such as Microsoft Excel) that the user may transition to while giving their slide show. The near-universal playback and the ability to accurately capture animations and other changes to the screen make the Flash flip-book the currently preferred embodiment.

Once the capture and processing step is started, the add-in returns control to the presentation program 402. The presenter 401 then delivers their presentation normally using the presentation program 402. The add-in has a monitor 406 which tracks the progress of the presentation program 402, 304 to determine when the presenter transitions the slides or pauses the presentation. When the user pauses the presentation, the audio or audio/video capture must be paused and then restarted when the user resumes. Also all timing markers must be adjusted for the pause time. This information is stored internally in the add-in for later processing.

After the presenter 401 has finished giving their presentation 305, the add-in takes control from the presentation program 402. It starts a task that ingests the slide contents 407 found in the presentation program 402 and transforms that information into a form appropriate for multimedia delivery 408, 307. This can be accomplished by either 1) having the add-in drive PowerPoint to output its slide content into HTML, 2) by having the add-in interpret the PowerPoint slide object model and output the data in any manner appropriate for delivery, or 3) creating a screen capture of the PowerPoint slides (and/or other applications displayed during the presentation) while they are presented and outputting them in a movie-like format. The first method is easy to accomplish and is appropriate if the output format is going to be HTML for viewing within most web browsers. It is accomplished by using the Microsoft PowerPoint object model (supplied by Microsoft to Microsoft Office developers) to loop over every slide shown in the slide show and invoking the HTML export method on each slide. The second approach of interpreting the PowerPoint object model requires the developer to develop a detailed understanding on how Microsoft PowerPoint interprets its model to format and generate the slide output. This must include an understanding of Master slides and their animations and how both interact with the slide content and its animation. While interpreting the PowerPoint object model for slide output requires more effort, it gives the implementers the most control and can be used to supports output in any format desired. This later approach would be appropriate, for example, if the desired output format was Macromedia Flash. The final approach captures the actual screen images (PowerPoint slides and/or other applications) as they are shown during the presentation. These images are then processed to create separate images for each slide or they are processed to create a movie that plays back along with the audio or audio/video capture. This option has been discussed in more detail above.

The add-in also outputs the timing information 406, 306 and optionally 409 takes the same slide content 407 and extracts additional metadata for the user 307. This metadata can be in many forms, such as a table of contents, a textual representation of the slide content or a search engine that returns specific slides based on their content. This information is generated by interpreting the PowerPoint slide object model and pulling out the appropriate information. Interpreting the PowerPoint object model for slide content and meta-data is simpler than interpreting it to generate slide output. The basic slide content without formatting and animation or interactions with the Master slide is easy to find in the object model and simple to interpret.

While this timing information and metadata can be output in multiple formats, a current implementation outputs this information is in an XML format. Below is a sample of an XML document that contains all of this information:

```
<?xml version=“1.0” encoding=“utf-8”?>
<i:session-info xmlns:i=“http://www.apreso.com/schemas/session-info-1.5”>
  <i:apreso-version>1.5.0</i:apreso-version>
  <i:total-presentation-size>0001324866</i:total-presentation-size>
  <i:start-timestamp>10/03/2003 13:50:19</i:start-timestamp>
  <i:end-timestamp>10/03/2003 13:50:46</i:end-timestamp>
  <i:duration>26524.359</i:duration>
  <i:powerpoint-source-file>Apreso_for_PowerPoint.ppt</i:powerpoint-source-file>
  <i:files-suffix>_files</i:files-suffix>
  <i:media profile=“High Quality (DSL Connection)” type=“Video” width=“320” height=“240”
              uri=“media.wmv” maxCompatibility=“False” codec=“” />
  <i:output-template>Basic</i:output-template>
  <i:presentation-properties>
    <i:description>Talk to Paolo</i:description>
    <i:name>demo</i:name>
  </i:presentation-properties>
  <i:presenter-properties>
    <i:title>Member of technical staff</i:title>
    <i:name>Steve Stillman</i:name>
    <i:organization>Anystream, Inc.</i:organization>
  </i:presenter-properties>
  <i:slides>
    <i:slide id=“256”>
      <i:number>1</i:number>
      <i:duration>11756.2545</i:duration>
      <i:location>slide256.htm</i:location>
      <i:thumbnail>thumbnails\slide256.jpg</i:thumbnail>
      <i:title>Welcome to Apreso for PowerPoint!</i:title>
    <i:notes />
    <i:text index-level=“1” bulleted=“False”>To use Apreso for PowerPoint you must
              begin &#xB;with a Microsoft PowerPoint presentation.</i:text>
    <i:text index-level=“2” bulleted=“False”>Getting started:</i:text>
    <i:text index-level=“3” bulleted=“True”>Use this sample presentation to test
              Apreso, or</i:text>
    <i:text index-level=“3” bulleted=“True”>Open an existing PowerPoint presentation,
              or</i:text>
    <i:text index-level=“3” bulleted=“True”>Create and save a new PowerPoint
              presentation.</i:text>
    <i:text index-level=“1” bulleted=“False”>Once you have opened your PowerPoint slide
              show, begin creating your rich &#xB;media presentation simply by selecting
              Start Presentation Capture from the &#xB;Apreso pull-down menu on
              PowerPoint main menu bar, or by clicking the Apreso icon.</i:text>
    <i:text index-level=“1” bulleted=“False”>For detailed instructions on using Apreso,
              refer to the Apreso User Guide, which can be accessed by selecting:
              &#xB;Start &gt; (All) Programs &gt; Apreso &gt; Apreso User Guide.</i:text>
    <i:tokens>
      <i:t>icon</i:t><i:t>create</i:t><i:t>can</i:t><i:t>or</i:t><i:t>powerpoint</i:t>
      <i:t>existing</i:t><i:t>with</i:t><i:t>getting</i:t><i:t>a</i:t><i:t>an</i:t>
      <i:t>all</i:t><i:t>show</i:t><i:t>have</i:t><i:t>save</i:t><i:t>menu</i:t>
      <i:t>programs</i:t><i:t>on</i:t><i:t>clicking</i:t><i:t>media</i:t>
      <i:t>down</i:t><i:t>apreso</i:t><i:t>the</i:t><i:t>rich</i:t><i:t>open</i:t>
      <i:t>accessed</i:t><i:t>welcome</i:t><i:t>you</i:t><i:t>using</i:t>
      <i:t>guide</i:t><i:t>new</i:t><i:t>presentation</i:t><i:t>once</i:t>
      <i:t>detailed</i:t><i:t>selecting</i:t><i:t>begin</i:t><i:t>by</i:t>
      <i:t>user</i:t><i:t>be</i:t><i:t>your</i:t><i:t>use</i:t><i:t>which</i:t>
      <i:t>to</i:t><i:t>and</i:t><i:t>sample</i:t><i:t>microsoft</i:t><i:t>slide</i:t>
      <i:t>pull</i:t><i:t>main</i:t><i:t>simply</i:t><i:t>this</i:t><i:t>start</i:t>
      <i:t>must</i:t><i:t>opened</i:t><i:t>creating</i:t><i:t>started</i:t>
      <i:t>instructions</i:t><i:t>bar</i:t><i:t>from</i:t><i:t>refer</i:t>
      <i:t>capture</i:t><i:t>toolbar</i:t><i:t>test</i:t><i:t>s</i:t><i:t>for</i:t>
    </i:tokens>
  </i:slide>
  <i:slide id=“257”>
    <i:number>2</i:number>
    <i:duration>8041.6395</i:duration>
    <i:location>slide257.htm</i:location>
    <i:thumbnail>thumbnails\slide257.jpg</i:thumbnail>
    <i:title>Easily Capture and Share &#xB;Everyday Presentations!</i:title>
    <i:notes />
    <i:text index-level=“1” bulleted=“False”>This is test slide&#xB;#2</i:text>
    <i:tokens>
      <i:t>share</i:t><i:t>test</i:t><i:t>is</i:t><i:t>presentations</i:t>
      <i:t>slide</i:t><i:t>2</i:t><i:t>capture</i:t><i:t>easily</i:t><i:t>this</i:t>
      <i:t>everyday</i:t><i:t>and</i:t>
    </i:tokens>
  </i:slide>
  <i:slide id=“258”>
    <i:number>3</i:number>
    <i:duration>5069.9475</i:duration>
    <i:location>slide258.htm</i:location>
    <i:thumbnail>thumbnails\slide258.jpg</i:thumbnail>
    <i:title>Incredibly Simple to Use!</i:title>
    <i:notes />
    <i:text index-level=“1” bulleted=“False”>This is test slide&#xB;#3</i:text>
    <i:tokens>
      <i:t>3</i:t><i:t>test</i:t><i:t>simple</i:t><i:t>incredibly</i:t><i:t>slide</i:t>
      <i:t>use</i:t><i:t>to</i:t><i:t>this<\i:t><i:t>is</i:t>
    </i:tokens>
  </i:slide>
  <i:slide id=“259”>
    <i:number>4</i:number>
    <i:duration>1656.5175</i:duration>
    <i:location>slide259.htm</i:location>
    <i:thumbnail>thumbnails\slide259.jpg</i:thumbnail>
    <i:title>Surprisingly Affordable!</i:title>
    <i:notes />
    <i:text index-level=“1” bulleted=“False”>This is test slide&#xB;#4</i:text>
    <i:text index-level=“1” bulleted=“False”>Press the escape key &lt;Esc&gt; on your
              keyboard to exit &#xB;this slide show to automatically create your
              Apreso.</i:text>
      <i:tokens>
        <i:t>surprisingly</i:t><i:t>key</i:t><i:t>your</i:t><i:t>on</i:t><i:t>this</i:t>
        <i:t>apreso</i:t><i:t>escape</i:t><i:t>esc</i:t><i:t>the</i:t><i:t>test</i:t>
        <i:t>automatically</i:t><i:t>affordable</i:t><i:t>show</i:t><i:t>4</i:t>
        <i:t>keyboard</i:t><i:t>slide</i:t><i:t>create</i:t><i:t>press</i:t>
        <i:t>exit</i:t><i:t>to</i:t><i:t>is</i:t>
      </i:tokens>
    </i:slide>
  </i:slides>
  <i:markers>
    <i:marker slideIndex=“1” slideId=“256” buildNumber=“−1” visitedCount=“1” time=“0” />
    <i:marker slideIndex=“2” slideId=“257” buildNumber=“−1” visitedCount=“1”
              time=“11756.2545” />
    <i:marker slideIndex=“3” slideId=“258” buildNumber=“−1” visitedCount=“1”
              time=“17779.9545” />
    <i:marker slideIndex=“4” slideId=“257” buildNumber=“−1” visitedCount=“2”
              time=“19727.6175” />
    <i:marker slideIndex=“5” slideId=“258” buildNumber=“−1” visitedCount=“2”
              time=“21745.557” />
    <i:marker slideIndex=“6” slideId=“259” buildNumber=“−1” visitedCount=“1”
              time=“24867.8415” />
  </i:markers>
</i:session-info>
```

The particular format of this document is not important to the implementation, however the kinds of information represented is. The <i:media> tag specified where the capture audio or audio/video file is located. The <i:presentation-properties> and <i:presenter-properties> blocks hold meta data on the presenter and presentation itself. This is often displayed in the final presentation. The <i:slides> block holds data on each slide of the presentation. This data is held in the <i:slide> block and the most important fields are attribute id which uniquely identifies the slide, <i:location> which points to the slide content for display during the presentation playback, and <i:title> which is the textual slide title and is used to show a table of contents. Finally, the <i:markers> block holds details on the when the slide are shown and how. For each slide, there is a <i:marker> tag specifying the specific slide to show using the slideId attribute and the display time using the time attribute.

Many PowerPoint presentations have slide animations that animate when the presenter invokes “Next” through the mouse or keyboard. Therefore these intra-slide events are represented by positive number counting each animation in the buildNumber attribute of the <i:marker> tag. When this attribute is processed during playback it invoked the appropriate code to animate the slide.

It should also be noted that presenters commonly show their slides out of order. They sometime jump to specific slides in the slide deck or they show a slide and then back up to a previous slide and then move forward again. The <i:marker> tag shown above supports both of these features. First the slideID attribute is not required to have the slides in slide order. The slides can be specified in any order and the output will track what the original presenter showed during their presentation. In the data shown above, the user steps through three slideIDs (256, 257 and 258) and then back up to slideID 257 and then continues forward again through slideID 258 and 259. Also notice that each slide that has been visited multiple times has a visitedCount attribute greater than one. It is used during presentation output to modify the behavior of the slide display. For example, it is used when the presenter backs to a previous slide. The slide output must be shown fully rendered without waiting for each animation, just like they saw the previoius slide before stepping to this slide, and the visitedCount is used to indicate this requirement.

Using this information and the timing information stored by 406, 306, the final multimedia package is created 410, 309. This step glues all of the data together into a single package 411. Web output is one embodiment and it is very compatible with PowerPoint's method of outputting HTML content. To create the complete package, additional HTML files must be added to the HTML slide content generated from within PowerPoint. One method to create these files into a use a series of XSLT transformations on the XML metadata document shown above. Each transformation would generate the content of one of the required HTML files. When each is finished, the complete package is ready for viewing. The disadvantage of this approach is that once the presentation has been created, any changes to the XML meta-data files (like changing the title or correcting the spelling of the author's name) will require the output to be completely regenerated using the XSLT transformations. While not difficult, this is an additional step that the user or support programs would have to know to perform after each edit.

An alternative approach is to use the ability of many web browsers to read in and query the content of XML documents. The final presentation is created by copying the additional HTML files to the media, slide content, and XML meta-data files. These HTML files would use Javascript to read in the XML metadata file into the browser and then dynamically generate the output using the appropriate information. Any edits to the XML meta-data files would be automatically be reflected in the output the next time it is shown. While both methods have been shown the work, the later method is more flexible and easier for the end user.

One important step is to synchronize the audio or audio/video delivery with the slide transitions. This can be done in several different ways depending on the ultimate delivery format. On the Internet, the two most common methods are to insert timing markers directly in a media stream or to use an external timing format such as JavaScript or SMIL to control events. Many streaming media format support the addition of timing markers being placed along side the audio or video and when the media player sees these markers it invokes the actions specified by the programmer. This is a useful feature, but it does require an additional processing pass over the media content to insert these makers. Since the timing information is stored in the metadata file, it can be used to generate a SMIL document (possibly using XSLT) that queries the media player and invokes the appropriate action. A third alternative is to interpret the meta-data directly in Javascript. During playback, the Javascript would monitor the player display time and when the time passes the next event, it would invoke the necessary code to transition to the next event. Since postprocessing of the media can be slow and creation of a SMIL document less flexible during editing (as per the XSLT discussion above), the Javascript approach is believed to be best suited for HTML output.

An alternative embodiment for the final multimedia package 410, 309 is to use Macromedia Flash as the delivery container. While it is a proprietary format, Macromedia has made the Flash format available to developers for products like this. This embodiment is particularly attractive if the slide content is being screen captured and converted into a flip-book. Flash is capable to support all desired aspects for multimedia output. It can present audio or audio-video 104 with the appropriate controls 105, it can show metadata 106, and it can display slide content 107. It can also synchronize different elements of the display. Flash also has near universal playback with support for Windows, Macintosh, Unix and Linux computers. Unless HTML output is a requirement, this is currently the preferred embodiment for delivery.

No matter what solutions are chosen for ultimate delivery, this final processing happens automatically and without user intervention.

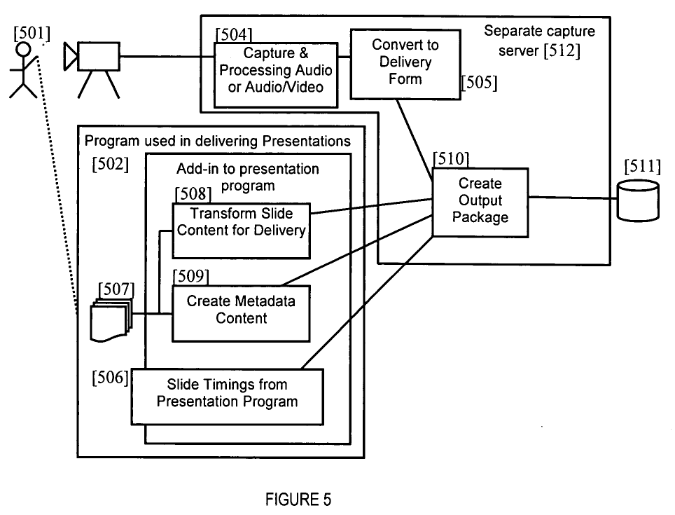

A common alternative embodiment is shown in FIG. 5. This embodiment separates the machine performing the capture of audio or audio/video from the machine delivering the presentation. A common situation where this embodiment is used is in a conference room that has a fixed video camera and server machine set up to capture the presentations given in this room. This machine is dedicated to the capturing of the video and therefore it can deliver more computation to the task and create a higher quality video capture and encoding for delivery. All the same processing occurs, however information must be transferred from the presentation machine 502 to the machine doing the audio or audio/video recording 512.

As in the single-machine example discussed earlier, to utilize this embodiment the presenter 501 only has to start the add-in with a single command (e.g. a mouse click) from within the presentation program and from that point forward, everything is automatically performed for them. At the end of the processing, they have a multimedia presentation without the requirement that they possess specialized skills or understand audio, video, event timing, and how multimedia data is assembled and presented. They only need to know how to start their presentation using the add-in from within their presentation program.

This invention can be used in multiple modes of operation, two of which are most common. The first common scenario is when the presenter is giving a presentation to an audience. The presenter just starts the add-in and delivers the presentation. When operating in this use model, the add-in can optionally start the presentation slide show, but delay the start of the capture and media processing step until manually directed by the presenter. This option is useful when the presenter wishes to display the title slide of their presentation while the audience is assembling without beginning the capture and media processing step, which otherwise would result in capture and processing of extraneous background audio and/or video. A second common mode of operation has the presenter at their desk self-publishing a multimedia presentation. Once they have completed this presentation, they can send it to one or more people who can then view the presentation without requiring the presenter to be there.

While specific embodiments of the invention has been described, it will be apparent to those skilled in the art that the principles of the invention are realizable by other systems and methods without departing from the scope and spirit of the invention, as will be defined in the claims.

1. A method for creating a multimedia presentation, which presentation comprises an audio or video recording of a session wherein a presenter presents an audiovisual presentation, said method comprising:
(i) said presenter presenting said audiovisual presentation,
(ii) making an audio or video recording of said presentation,
(iii) wherein timing data comprising data for start, end and transition events within said audiovisual presentation are automatically, and without manual processing, incorporated into said audio or video recording, so as to allow said events to be used on playback to coordinate the audio or video portion of said multimedia presentation with the audiovisual portion thereof.
